(19) United States
(12) Patent Application Publication
(10) Pub. No.: US 2004/0048605 A1
(43) Pub. Date: Mar. 11, 2004

(54) Wireless communications system

(76) Inventors: Robert A. Schaefer, San Francisco, CA (US); Shahid Javed, Chandler, AZ (US)

Correspondence Address: Paul K. Tomita, Esq., DERGOSITS & NOAH LLP, Suite 1450, Four Embarcadero Center, San Francisco, CA, 94111, US

(21) Appl. No.: 10/349,809

(22) Filed: Jan. 22, 2003

Related U.S. Application Data
(63) Continuation-in-part of application No. 10/242,333, filed on Sep. 11, 2002.

(51) Int. Cl. H04M 1/66; H04M 1/68; H04M 3/16

(52) U.S. Cl. 455/414.2; 455/411

(57) ABSTRACT

A system for wireless communications includes multiple portable digital devices which automatically and selectively communicate with each other. Each portable digital device has a proximity transceiver and an electronic memory which stores the user's and listing of matched identification codes which represents all compatible PDD users. During operation, the portable digital devices communicate with each other by transmitting identification codes and receiving identification codes. The PDD compares the received identification code to the listing of matched identification codes to determine if there is a match. If the received identification code is on the listing of matched identification codes, a match is detected the match indicators of the PDDs are actuated to inform the users that a match has been detected.

This application is a continuation in part of copending U.S. patent application Ser. No. 10/242,333 filed Sep. 11, 2002 titled “Wireless Communications System” which is hereby incorporated by reference.

### BACKGROUND

Radio frequency communications have existed for many years and are now used in a wide variety of applications. Large systems are capable of transmitting voice and digital information wirelessly over large distances. As radio frequency technology has progressed, the transceivers have become smaller and more energy efficient. Personal cell phones, pagers and other radio frequency communications devices have become well known consumer electronics. Some personal digital assistants (PDAs) utilize radio frequency technology to wirelessly access the internet.

Short range radio frequency communications such as Bluetooth have been developed which have a limited communications range but are highly energy efficient. Short range radio frequency transceivers are used for communications between personal computers and peripheral devices such as: PDAs, keyboards, mice, and printers. Energy efficiency is of particular importance to portable peripheral devices which are generally powered by rechargeable batteries.

Some systems have been developed which allow users of radio frequency devices having a “common interest” to communicate or exchange information with each other. In these systems, a data signal is wirelessly transmitted from a first radio frequency (RF) device to a second RF device. The data signal includes encoded information indicative of a specific interest. If the second device determines that there is a common interest based upon the received data signal, additional information wirelessly exchanges with the first RF device.

A problem with these common interest communications systems is that users are matched based only upon a common interest, even though they are otherwise incompatible. What is needed is a more intelligent matching system which matches users based upon the compatibility of the individuals rather than simply a common interest.

### SUMMARY OF THE INVENTION

The present invention is a wireless communications system which allows portable digital devices (PDDs) to automatically and selectively exchange information with other compatible PDDs which are within the vicinity of each other. The PDDs are small battery operated units containing a microprocessor, an electronic memory and short range radio frequency transceivers. The PDD may be built into a small integrated circuit which may be incorporated into other devices such as PDAs, pagers or cell phones.

The matching of the PDDs is based upon personal information and search data of the user. The personal information includes descriptive information about the user and the search data includes characteristics of a person that the user would like to meet. A server computer includes a user database which stores the personal information and search data for all PDD users. The server conducts match searches which compare the personal information and search data of the user to the personal information and search data of all other users. A match requires that the first user's personal information matches the search data of the other user and the other user's personal information matches the search data of the first user. The match search produces a listing of user identification codes which match the user's personal information and search data and visa versa. This listing of matched identification codes is downloaded to the PDD using a telephone line, an internet connection, a personal computer or directly input into the PDD. The matched identification code listings may also be stored on the user database and may be automatically updated so that the database accounts for changes to the database. The listing of matched user identification codes can simply be downloaded to the PDD upon request.

The PDDs are carried by their users into areas where other PDD users may be present. Because the personal digital devices utilize short range radio frequency transceivers, communications are limited to PDDs which are within the transceiver transmission range. Each PDD runs a program which automatically initiates communications with other PDDs within the transmission range of the radio frequency transceiver. The transmission range may be relatively short so that the matched parties can easily locate each other.

In an embodiment, the PDDs transmit and receive (exchange) identification codes via radio frequency communications. The identification code is stored in memory and analyzed for a match by comparing the identification code to the listing of matched identification codes. If the identification code is on the matched listing and the identification code has not been previously received, the match indicator of the PDD is actuated. If the identification code is not on the listing of matched user's the PDD may request profile information which may include the user's personal information and/or search data, to perform a secondary match check. Once the profile information is received, the PDD compares each users search data and personal information. If each user's personal information matches the other user's search data, a match is established and the match indicators of both users' PDD is actuated. If the PDDs are not matched, the first PDD may transmit a signal indicating that the PDDs are not matched and the devices can resume listening for PDD identification codes. The PDD stores received identification codes to prevent actuating the match indicator if the previously received identification code is received again. If a match is not established, the match indicators are not actuated and the PDDs return to transmitting and receiving information.

In another embodiment, the PDD can transmit profile information, biometric information, photographs and keyword text in addition to the identification code. Other PDDs in the area receive the information, identify the information type and process the information accordingly. Based upon the received information the PDDs transmit an appropriate response. This communications flexibility allows the PDDs to function in response to variable transmitted information and in multiple operating modes. Biometric information can include physiological and behavioral characteristics such as: height, age, weight, allergies, skin and eye pigmentation, etc. The photograph can be a digital image which is transmitted electronically. Keyword information can include: interests, hobbies, employment, etc. The keyword information may also be used as a negative condition in order to avoid certain people. For example, the PDD may be configured to avoid lawyers.

The transmission of information between PDDs can include the identification code alone or in combination with any other type of digital information. Alternatively, the identification code may be combined with the user's profile information, biometric information, photographs and keyword text. By recognizing the protocol, the transmitted information can be recognized and interpreted by the PDDs. In the simplest form the broadcast protocol is simply the identification code. Alternatively, the broadcast protocol may be: 1) identification code+profile, 2) identification code+profile+text, 3) identification code+text or 4) any other combination of information.

The match indicator of the PDD can be a light, vibration, sound or any other signal. A manual switch may be used by the user to adjust the match indicator to the desired actuation mode. Because there may be many PDD users in a location, the match indicator may include a mechanism which helps to identify the matched PDD user. The matched PDDs may produce matching colors to assist the users in identifying each other. When the match indicator is actuated, the PDD may continue transmitting or receiving information allowing the users to identify the matched user in a silent mode.

The user may have control over other aspects of the matching process. For example, the user may configure the PDD to block any identification code from a specific PDD user who would otherwise be a match. This allows the user to prevent matching with any specific user. In an embodiment, a user can also prescreen a match before the match indicators are actuated. The potential matched user's information can be displayed before the match indicator is actuated and based upon this information the user can accept or reject the matched user. The displayed information can include: photos, personal information, text, etc. If the match is rejected, the match indicators are not actuated and the PDDs continue to search for matches. If the match is accepted, the match indicators are actuated and the matched PDD users can meet each other.

In most situations it is desirable to contact the matched user soon after being informed of a match, however it is also possible for the user to deactivate the match indicator and access information about the matched users at a later time. In an embodiment, the stored identification code may be used to look up additional information about the matched user through the user database through the server computer.

In an embodiment, the PDDs can communicate over a range of frequencies. The utilization of various frequencies enables more PDDs to communicate in a crowded area while avoiding interference due to exceeding the wireless communications bandwidth for a single frequency. Various modes of operation are possible. For example, specific frequencies may be used for specific types of communications. A first set of frequencies may be used by individuals interested in dating with a first frequency or a set of frequencies assigned to males interested in meeting females and a second frequency for females interested in meeting males. A second frequency or set of frequencies may be used by PDD users looking for other types of relationships. In this embodiment, the PDD users can monitor the frequencies used by their target group. Alternatively, the PDDs may utilize spread spectrum technology which continuously changes frequencies and allows many devices to communicate using the same range of frequencies while not having communications disrupted by colliding signals. The spread spectrum communications may also be configured such that assigned sets of frequencies are used for specific interest groups.

The PDD may be connected to a personal computer which is used to configure the operation of the PDD. In some situations the PDD's communications frequencies may be determined by the type of match search being conducted or set by the user through the personal computer. In the preferred embodiment, the PDD is used with a personal computer that has access to the internet and the server computer which stores the PDD user database. Because the PDD user database may contain confidential information, certain safeguards may be implemented to prevent unauthorized access. The exchanged contact information may include an authorization code which allows access to the PDD user's database profile stored on the database. The database profile includes additional information about the individual which may be of interest to the matched user.

The inventive wireless communications system provides users with a means for automatically and selectively identifying compatible PDD users. The communications system has a variety of entertainment, disability and business applications which will be described in more detail.

### BRIEF DESCRIPTION OF THE DRAWINGS

The invention is herein described, by way of example only, with reference to embodiments of the present invention illustrated in the accompanying drawings, wherein:

FIG. 1 illustrates the four ways in which the portable digital device may be carried by the user;

FIG. 2 illustrates the variable transmission radius of the personal digital device;

FIG. 3 illustrates transmission radius requirements for communications between personal digital devices;

FIG. 4 illustrates an embodiment of the inventive system in which the portable digital devices require an enabling or disabling signal for communications;

FIG. 5 illustrates two configurations for downloading the program onto a personal computer;

FIG. 6 illustrates three configurations for connecting the PDD to the personal computer;

FIG. 7 illustrates a screen shot of an exemplary graphical user interface for inputting a user's personal information;

FIG. 8 illustrates a flow chart of the operation of the portable digital device in a peer to peer operating mode;

FIG. 9 illustrates a flowchart of the operation of the PDD in an enabling signal mode;

FIG. 10 illustrates a block diagram of the application specific integrated circuit (ASIC) of the portable digital device;

FIG. 11 illustrates a block diagram of some components of the portable digital device which may be fabricated as one or two application specific integrated circuits; and

FIG. 12 illustrates the various digital devices into which the portable digital device can be incorporated.

### DETAILED DESCRIPTION

The inventive wireless communications system allows portable digital devices (PDDs) to automatically communicate and selectively exchange information with other PDDs when the devices are within the transmission radius of each other. The PDDs are small devices which contain personal identification code data which is also input by the user. The PDD may be worn or carried by a user when he or she attends social gatherings.

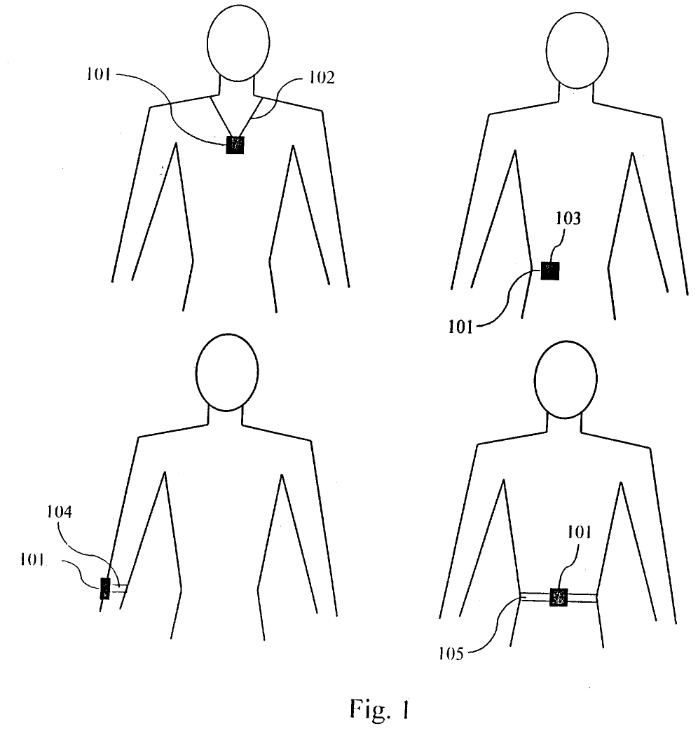

With reference to FIG. 1, various means for wearing the PDD 101 are illustrated. The PDD 101 is a very small device and light weight. The small physical characteristics allow the PDD 101 to be easily worn, carried or even integrated into various consumer electronic devices including mobile phones, wrist watches and personal digital assistants (PDAs). The PDD 101 may be placed within a pendant which is attached to a necklace 102 and worn around a user's neck. The pendant may be a sculptured piece which is preferably made of a material which is transparent to radio frequency waves. The PDD 101 may have a clip 103 which can be attached to the user's clothing or integrated into a pager. The PDD 101 may be attached to a bracelet 104 which can be worn on the user's wrist, jewelry or integrated into a wrist watch. The PDD 101 may also be attached to a waist band or belt 105 which is worn by the user. Alternatively, the PDD 1101 may be simply carried by the user in his or her pocket or purse.

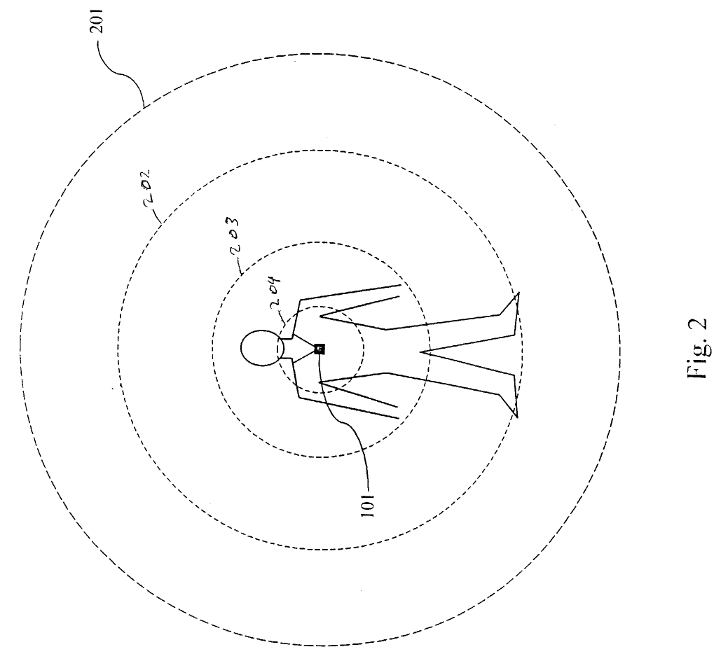

The PDD communicates with other PDDs which are in a physical proximity. With reference to FIG. 2, the PDD 101 has a specific transmission radius 201 which may extend about 30 feet from the user. The transmitter strength of the PDD 101 may be controllable by varying the power output of the transmitter. By reducing the power to the transmitter, the radius of transmission of the PDD's 101 is reduced. In an embodiment, the PDD may be able to adjust the communications range between a long transmission radius 201, a medium transmission radius 202, a short transmission radius 203 and a very short transmission radius 204. The longer transmission radius 201 will be able to communicate with a larger area of PDD users. The shorter transmission radii 203, 204 have the benefit of lower power consumption and longer battery life. The shorter transmission radii may also improve the effectiveness of the PDD in a crowded space by only communicating with other PDDs in a closer proximity to the user.

The user may control the transmission radius using a manual switch on the PDD which adjusts the power output of the RF transmitter. Alternatively, the PDD may include an automatic RF transmitter power output controller which is controlled by the number of PDDs detected. If a large number of PDDs are detected the PDD can automatically reduce the transmission radius thereby reducing the number of detected PDDs. Conversely, if few PDDs are detected, the PDD can automatically increase the transmission radius. By adjusting the transmission radius the PDD detection rate can be regulated to a level which is manageable by the PDD. The PDDs may utilize various frequencies depending upon the use of the PDD or the mode of operation.

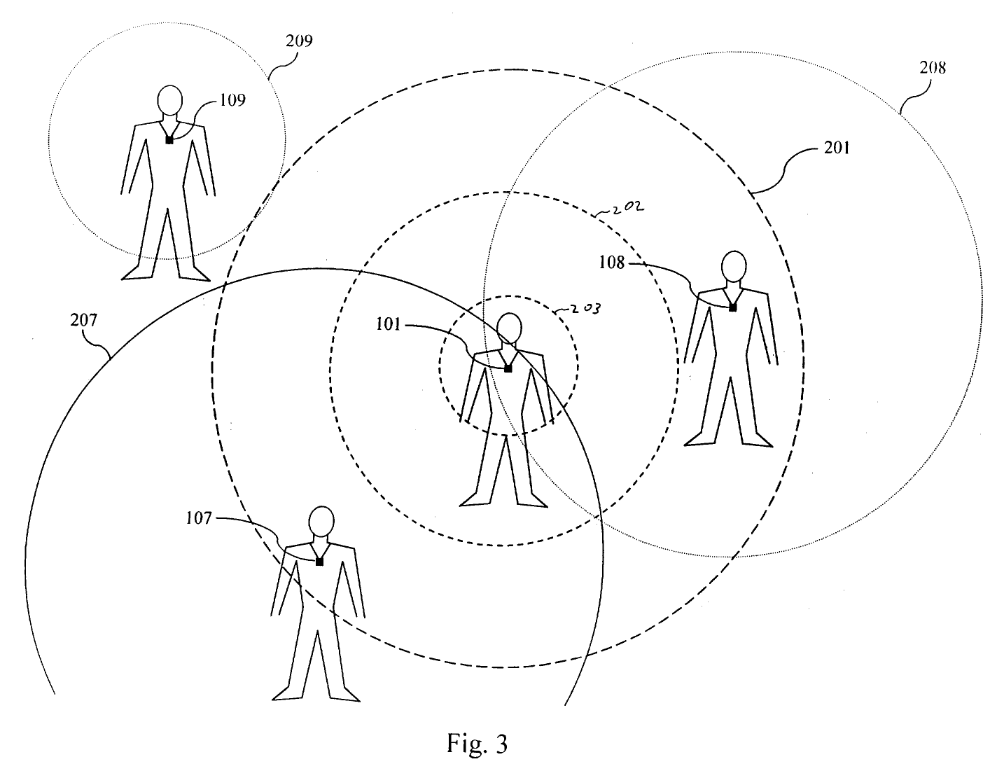

FIG. 3 illustrates a group of PDDs 101, 107, 108, 109 some of which can communicate with each other. If the first PDD 101 is transmitting at the long transmission radius 201, the first PDD 101 can communicate with a second PDD 107 and a third PDD 108. The first PDD 101 can communicate with the second PDD 107 because the second PDD 107 is within transmission radius 201 and the first PDD 101 is within transmission radius 207. Similarly, the first PDD 101 can communicate with the third PDD 108 because the third PDD 108 is within transmission radius 201 and the first PDD 101 is within transmission radius 208. The first PDD 101 cannot communicate with a forth PDD 109 because the fourth PDD 109 is outside transmission radius 201 and also because the first PDD 101 is outside transmission radius 209.

If the transmitter power for the first PDD 101 is reduced to transmission radius 202, communications with the second PDD 107 and a third PDD 108 are no longer be possible. Although the first PDD 101 is within transmission radius 207 and transmission radius 208, neither the second PDD 107 nor the third PDD 108 are within transmission radius 202. Communications between the second PDD 107, the third PDD 108 and the forth PDD 109 are not possible because none of these PDDs are within the respective transmission radii 207, 208, 209.

An exception to this limitation is when the PDDs are operating in an ad hoc mode which allows PDD users to spontaneously form a wireless LAN. Information is shared amongst all PDDs which are part of the spontaneously formed wireless LAN within their meeting room. Because the PDD users form a network, the communications range is extended. For example, a PDD user on one side of a room can communicate with another PDD user who is well beyond the point-to-point range of 802.11 or other wireless standard, because the identification signal hops from PDD to PDD until all PDDs in the network receive the signal. The ad hoc mode extends the range of the wireless communications depending upon on the concentration of wireless users.

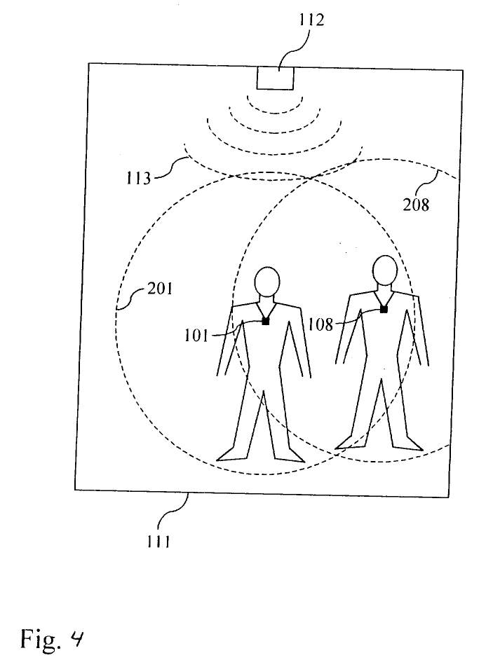

In an embodiment, communications between PDDs requires an enabling signal to be received by the PDDs and each PDD to be within the transmission range of the other PDD. FIG. 4 illustrates a transmitter 112 which emits an RF enabling signal 113 which is received by a first PDD 101 and a second PDD 108. The transmitter 112 may be controlled by a host computer (not shown). After receiving the enabling signal 113 the PDDs 101, 108 can communicate because the first PDD 101 is within transmission radius 208 and the second PDD 108 is within transmission range 201. The enabling signal embodiment allows communications between PDDs 101, 108 to be controlled by a third party. The enabling signal 113 emanating from the transmitter 112 is used to control communications between PDDs 101, 108 within a defined space 111. The transmitter 112 power output may not be restricted by a limited electrical power supply and may have a very long transmission radius which allows all PDDs within the room 111 to communicate.

In another embodiment, the transmitter 112 may emit a disabling signal 113 which functions to deactivate communications between the PDDs 101, 108. In this embodiment, communications are possible when the first PDD 101 is within transmission range 208 and the second PDD 108 is within transmission range 201 and a disabling signal 113 is not received. In this embodiment, the PDDs 101, 108 can normally communicate independently however, communications can be terminated by transmitting a disabling signal 113. When the PDDs 101, 108 receive the disabling signal, they may display a message indicating that communications are not authorized.

In either configuration the enabling/disabling signal transmitter controls the communications in a space. If the room in which communications are to be controlled is large or complex in shape, multiple enabling or disabling signal transmitters can be dispersed throughout the area to be controlled. By dispersing multiple transmitters all areas of the room may be within the transmission radius of a least one enabling/disabling signal transmitter. The transmission range of the enabling/disabling signal transmitters can be much greater than the transmission range of the PDD. Thus, the transmitters do not have to be within the transmission radii of the PDDs to control communications between PDDs within a defined space.

The enabling or deactivation signal allows communications between PDDs in a defined area to be controlled by a third party. The third party may be the owner or manager and the defined area may be a building or an open space. The defined area may be a club having specific hours of operation. The owner or manager can discontinue the operation of all PDDs within the club by turning off the enabling signal or turning on a deactivation signal. By terminating PDD communications patrons may have an incentive to leave the club. Similarly, PDD communications can be temporarily suspended for example if a public announcement needs be made, advertisement message or in the event of an emergency.

In an embodiment, the area transmitter may transmit advertising information to all PDDs in the transmission range. When the advertising information is received, an advertising message may be displayed on the visual display or an advertising message may be played over the PDD unit's speaker. If the visual display of the PDD is exposed, the advertisement may be seen by people in the vicinity. In an embodiment, promotional offers may be transmitted to PDD users for such things as drink discounts, promotional prizes or other contests. A drink discount may be transmitted to all or specific types of PDD users in the area, such as women who's astrological sign is Libra which are identified by their birthday. The picked PDD user or users may bring their PDDs to a designated area to claim their drink discount. Alternatively, the area computer may select one person in the area as the winner of a prize. The area computer may then transmit a special signal to the winning PDD and an output device on the winning PDD informs the user that the PDD has been selected to win the prize.

For a PDD to detect matched PDDs, a listing of matched user identification codes must be input into the PDD's memory. There are various methods for obtaining the listing of matched identification codes and transferring the listing to the PDD memory. In the preferred embodiment, the listing of matched identification codes is obtained by searching a PDD user data base using the user's personal profile as a search filter. The personal profile may be input into a personal computer using a graphical user interface which is displayed on the computer screen. The personal computer allows the user to input his or her personal information and search data and download a listing of matched user identification codes from the server computer.

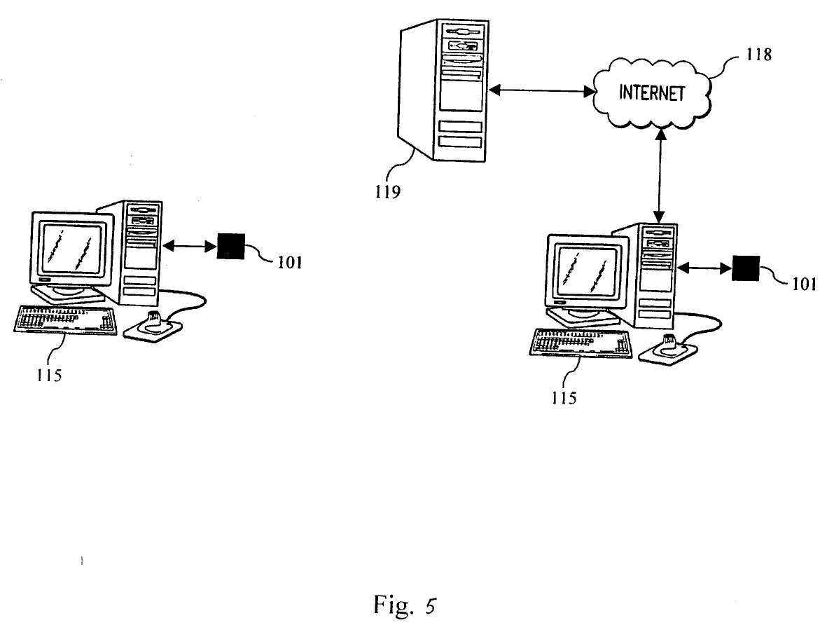

FIG. 5 illustrates two exemplary configurations for transferring information to a personal computer. Information may be loaded onto the computer 115 through portable media such as a floppy, compact or DVD disc containing the program. Alternatively, information may be downloaded to the computer 115 from a server computer 119 through in internet connection 118 using a web browser program.

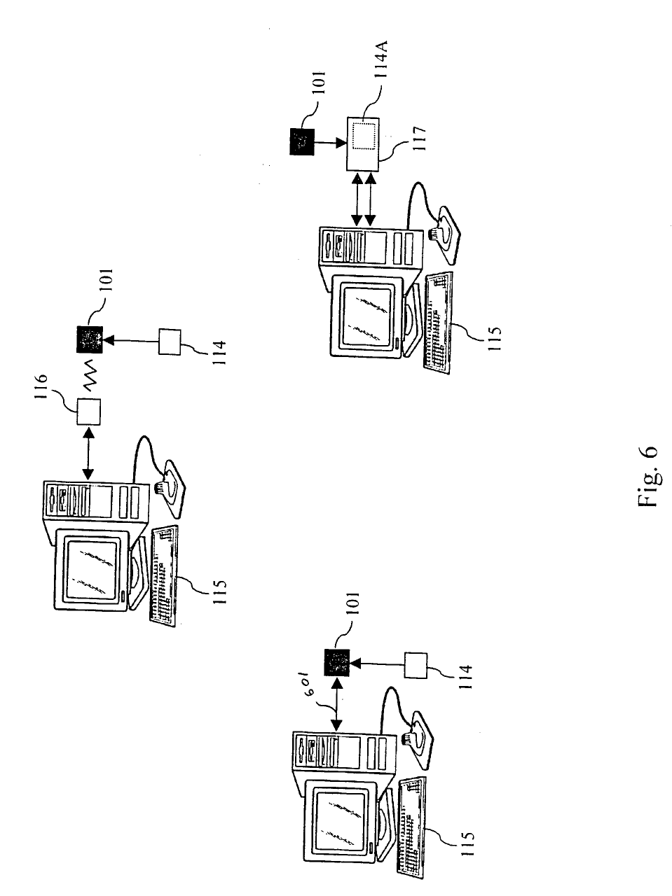

FIG. 6 illustrates three exemplary configurations for connecting the PDD 101 to the personal computer 115. The PDD 101 may be connected directly to the personal computer 115 using a wired cable 601. The wired cable 601 may be a USB, serial, RS-232 or any other type of cable including optical which is capable of transmitting data between the PDD 101 and the computer 115. Power to recharge the PDD 101 batteries may be supplied by an external power source 114 such as an AC adapter which would plug into a standard electrical outlet. Alternatively, electrical power to recharge the battery may be drawn from the computer 115 through the cable 601.

The PDD 101 may also utilize its wireless RF transceiver to exchange information with the computer 115. A compatible wireless RF transceiver 116 may be attached to the computer 115 and information may be exchanged by placing the PDD 101 within the transmission radius of the computer's RF transceiver 116. The wireless communications have the advantage of not requiring a physical connection between the computer 115 and the PDD 101. In this embodiment, electrical power may be supplied to the PDD 101 through an external power source 114.

In yet another embodiment, a docking station 117 is connected to the computer 115. The PDD 101 is placed in the docking station 117 to connect the PDD 101 to the computer 115 and an external power source 116. The docking station 117 may also have control buttons which can be used by the user to initiate the exchange of information or synchronize data stored on the PDD 101 and the computer 115. The docking station 117 is the preferred system because it provides the simplest connection between the PDD 101 and the computer 115.

In yet another embodiment, the PDD may be a module or integrated analog-digital chip which is inserted into a module slot or added the existing design of a PDA device such as a Palm, Casio, Sony or Handspring PDA or a cellular phone. Most PDAs are able to exchange information with a computer through a cable, cradle, wireless infrared or RF transceivers. Some other PDAs such as the Palm VII and combination DPA/cell phones such as the Handspring Treo have wireless internet access which may also serve as a communications connection with a computer. In these embodiments, listing of matched user identification codes may be downloaded to the device using any of the existing communications or data input capabilities of the PDA device. The module or integrated A/D chip may have all the capabilities of the described PDDs including the ability to decode profiles in the event that an identification code is not matched to the downloaded listing of matched user identification codes.

In an embodiment, the PDD may be an entertainment device used for dating by adults. A listing of matched PDD identification codes may be loaded into the PDDs. The listing of matched PDD identification codes may be determined by searching a PDD user database using the user's personal profile as a filter. The personal profile may include personal information and search data. The personal information relevant to dating may include: gender, age, ethnicity, physical characteristics, education, income, etc. The search data will include information which is representative of the type of person that the user would like to date and will include: gender, age range, ethnicity, physical characteristics, education, income, etc. The search data may allow for an acceptable range in certain situations.

Because personal information, search data and identification code listings can be highly confidential, an encryption or security scheme may be used to prevent confidential information from being accessible to unauthorized individuals. The encryption method converts the confidential information into a format that is not easily deciphered by an unintended recipient of the information. Similarly, secure communication channels may be used which are not easily intercepted by an unintended recipient. Using these known systems, personal information and search data is protected from unauthorized dissemination.

In the preferred embodiment, the user can use the identification codes to obtain additional information about an individual through a PDD user database on the server computer through an internet connection. As discussed, the PDD has a limited memory which may be insufficient to store a significant quantity of information. With the identification code, information about the individual associated with the identification code can be obtained. This additional information may include: a photograph and a detailed personal description written by the user.

Certain personal information may be confidential which is only accessed with the user's express permission. In this embodiment, the confidential personal information associated with an identification code is more securely stored in the PDD user database. When another user attempts to access the confidential personal information, a message is transmitted to the person associated with the confidential personal information informing the user that access is being requested and identifying the requestor. The user can either grant or deny access to the requestor. Only if access is granted will only the requester be permitted to access the confidential personal information. If access is denied, the computer transmits a message to the requestor indicating that access to the confidential personal information has been denied. Encryption may also be used to prevent a hacker from deciphering the confidential information if the user database is accessed without authorization.

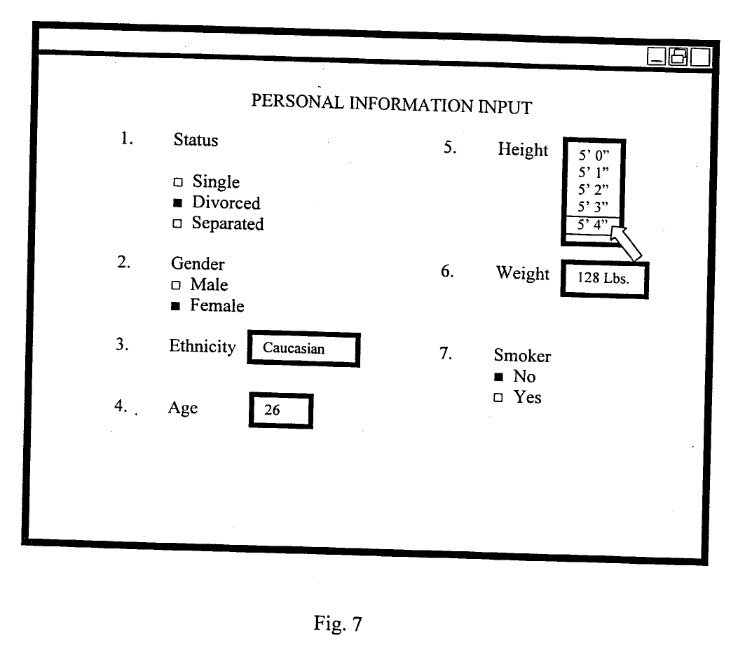

Personal profile information may be input directly into the PDD or input into a personal computer and then down loaded to the PDD. Because the PDD may have input and display limitations, the personal information is preferably input using a personal computer having a graphical user interface (GUI) PDD program. An example of the GUI used to input the personal profile information is illustrated in FIG. 7. For example, the first input is “Status.” The user can input this information by pointing the cursor over the appropriate input “Single” or “Divorced” or “Separated” and clicking a button on the computer's input device. Other information such as age can by input by typing in the appropriate number through the computer keyboard or by clicking on a drop down menu inputs. In certain input fields, it may be appropriate to input text to create a more detailed and unique personal information file. For example, a person may be particularly interested in meeting someone who likes tennis. By inputting tennis into the text field, this information can be used to identify other PDD users who have an interest in tennis and screen users who are not interested in tennis.

The search data inputs may be similar to the personal information except that the search data is representative of a person that the user is interested in dating and exchanging contact information with. The search data is typically broader than the personal information. For example in a dating application, the search data inputs may be a range of ages, heights, and weights. The search data may also include a keyword(s) which must appear in a compatible personal information file for a match. A graphical user interface like that used to input the personal information is used to input for the search data.

The inventive system for matching of personal information and search data between two individuals is a screening method which is used with a database to produce a listing of compatible user identification codes. Many internet dating systems exist which have accessible databases of users which allow individuals to search through published listings of members profiles. The profiles on the database contain detailed text information about the member and frequently also contain a photograph of the member. When search data describing a person is input, the system searches the database and produces a listing of service member profiles which meet the search data. The recipient of the listing must then go through each profile in the listing to determine if there is a potential match. Frequently the recipient does not meet the requirements of the listed profile.

The inventive search method improves upon the single search method by utilizing both the user's personal information and search data to find compatible users from a PDD user database. In an embodiment, the user's personal information and search data are transmitted from the personal computer to the server computer. The same information used to create a profile for an internet dating service may also be used as the personal information and search data of the inventive PDD. The server computer may search the user database by first comparing the user's search data to the personal information of all users to extract a first listing of potential matches. The system would then compare the search data of the listed potential matches to the personal information of the user to produce a final listing of matched user identification codes. Various alternative search methods are known which will produce the same listing of matched user identification codes. The listing of user identification codes is transmitted back to the personal computer and downloaded to the user's PDD.

Table 1 is a simplified listing of the profiles of eight users. The profile information includes search data and personal information. During actual use the matching process will involve many more PDD users.

TABLE 1

| | Identification | | | | | | |
|---|---|---|---|---|---|---|---|
| | Code | Status | Sex | Age | Height | Weight | Smoker |
| First User | 1 | Single | Male | 28 | 6′ | 185 lbs. | Yes |
| Personal Info | | | | | | | |
| First User | 1 | Single or | Female | 22-31 | any | 150 lbs. | Yes or No |
| Search Data | | Divorced | | | | or less | |
| Second User | 2 | Divorced | Female | 26 | 5′4″ | 128 lbs. | No |
| Personal Info | | | | | | | |
| Second User | 2 | Single or | Male | 24-33 | 5′5″- | 210 lbs. | Yes or No |
| Search Data | | Divorced | | | 6′6″ | or less | |
| Third User | 3 | Single | Male | 39 | 5′2″ | 185 lbs. | No |
| Search Data | | | | | | | |
| Third User | 3 | Single or | Female | 35-44 | any | 120 lbs. | Yes or No |
| Personal Info | | Divorced | | | | or more | |
| Fourth User | 4 | Divorced | Female | 50 | 5′8″ | 140 lbs. | No |
| Search Data | | | | | | | |
| Fourth User | 4 | Single | Female | 45-60 | 5′5″+ | 210 lbs. | No |
| Search Data | | | | | | or less | |
| Fifth User | 5 | Single | Male | 21 | 6′ | 220 lbs. | Yes |
| Personal Info | | | | | | | |
| Fifth User | 5 | Single or | Female | 22-31 | any | 150 lbs. | Yes or No |
| Search Data | | Divorced | | | | or less | |
| Sixth User | 6 | Divorced | Female | 29 | 5′0″ | 150 lbs. | No |
| Search Data | | | | | | | |
| Sixth User | 6 | Divorced | Male | 24-35 | 5′2″ to | 210 lbs. | Yes |
| Personal Info | | | | | 6′ | or less | |
| Seventh User | 7 | Single | Male | 63 | 6′5″ | 125 lbs. | Yes |
| Search Data | | | | | | | |
| Seventh User | 7 | Single or | Female | 30-60 | any | 150 lbs. | Yes or No |
| Search Data | | Divorced | | | | or less | |
| Eighth User | 8 | Divorced | Female | 31 | 5′4″ | 130 lbs. | No |
| Personal Info | | | | | | | |
| Eighth User | 8 | Single | Male | 35-40 | 6′ | Any | No |
| Search Data | | | | | or less | | |

When the first user's search data is compared to the other (2-8) users' personal information, the search data only matches the second, sixth and eighth users. The first user's search data does not match the third, fifth and seventh users because the search data requires a female and the third, fifth and seventh users are male. The first user's search data did not match the fourth user because the search data required the age to be 22 to 31 years and the fourth user is 50. The first user's personal information is then compared to the search data of the second, sixth and eighth users. The first user's personal information only matches the search data of the second and sixth users. The first user does not match the eighth user's search data because he is too young and a smoker. The search results of the user database for the first user will include identification codes 2 and 6 which is the listing of matched user identification codes. The listing of matched user identification codes can be transferred to the PDD through the personal computer.

In an embodiment, each PDD user has a profile which includes an individual identification code, personal information and search data. The users' personal information, search data and identification code are all stored on a PDD user database on the server computer. The server computer searches the PDD user database for matched PDDs based upon the user's personal information and search data and produces a listing of identification codes corresponding to matched PDD users. This listing of matched PDD identification codes is stored on the PDD user database. The current listing of matched PDD users is constantly changing because new PDD users are being added and search information and personal data are constantly changing.

The listing of matched PDD identification codes has the advantage of simplifying the operation of the PDD. Each PDD only transmits an identification code which is a small amount of information. This makes the PDD more efficient because the amount of information transmitted and received is small and the computations required by the PDD are fairly simple. The PDD does not have to perform a matching analysis of the personal information and search data which reduces the required processing power. A drawback is that the matched PDD listing may frequently require updating. The listing of matched PDD user identification codes is only accurate at the time that it is downloaded from the server. The listing does not include identifications codes for users who have been placed on the user database or modified their files after the listing download. The listing needs to be updated regularly to maintain accuracy.

Various other types of information may be included in the personal profile. This additional information may be stored on the PDD user database. The personal profile may include a digital photograph of the individual. The digital photograph may be input into the personal computer and stored in the user's personal information section of the server file. The photograph may be used to help identify an individual. In an embodiment, the photo information is transmitted with the identification code during PDD communications. The photo may then be displayed on the PDD receiving the information on a visual display when a PDD match indicator is actuated. The displayed digital photograph can be viewed to assist the PDD user in locating the matched PDD user. The picture file may be about 1-10 kilobytes in size. The PDD may have an internal memory of about 256 KB or more of total memory.

In an embodiment, the PDD user can review an electronic photograph of a matched PDD user before the match indicators are actuated. When a matched identification code is detected, electronic photographs of the matched PDD users are exchanged. The photograph may be transmitted by the matched PDD or downloaded with the matched identification codes. The users review are notified that pictures have been exchanged and after reviewing the photo, the user can authorize the actuation of the match indicators. The users may accept or reject the match actuation by pressing control buttons on the PDDs. If both users authorize the actuation of the match indicators, the match indicators are actuated. Alternatively, if either or both users reject the match actuation, the PDDs return to transmitting and receiving identification codes.

In an embodiment, the user can also control the matching process by removing any codes from the listing of matched user identification codes. The user may wish to remove undesirable codes for various reasons. For example, the multiple users may be friends who already know one another and do not want their PDDs matching when they are together. The user can browse through the personal information of the matched identification codes and find additional information that is unappealing to the user. For example, certain users may be interested in certain physical characteristics which are not easily quantified through the personal information statistics but easily detected in a photograph. By searching through the photographs, the user can remove matched identification codes of users who do not have these characteristics. In other instances, the user may know the identity of a matched identification code.

The listing of identification codes to be removed is transmitted to the server computer which removes the user's identification code from the matched user's listing of matched users. The server computer can continuously update the matched listing for each user allowing the server to instantly transmit updated matched user listings rather than perform match processing when the user requests an updated listing from the server. The removal feature allows a user to remove the matched user from the listing of matched users rather than potentially meeting the matched user.

Each PDD user can access the server computer through the internet and request a current matched identification code listing, update the personal information or update the search data. When a listing of matched PDD users is requested, the listing of matching identification codes is transmitted back to the user and loaded into the memory of the user's PDD. A large number of matched user identification numbers can be stored in the PDD's memory because each identification code requires a very small amount of memory. For example the identification code may require 32 bits of memory, thus a listing of 1,000,000 matched identification codes would only require 4 megabytes of memory. In order to keep the listing of matched identification codes current, the user must periodically updated the listing by accessing the PDD user database. As new users are added, search data is modified or personal information changes, the listing of matched PDD users will also change. The PDD user database may continuously update the user's matched user listing and store this listing

During use, each PDD transmits its own identification code and listens for the identification codes of other PDDs. When the PDD receives an identification code, it compares the code to the listing of matched identification codes in memory and determines if the identification code has been received in the past. If the received identification code is on the list of matched identification codes and the PDD has not received the identification code in the past, the match indicator is actuated. The match indicator is actuated to inform the user of the PDD that a match has been established in the transmission proximity. Because the transmission range of the PDDs is short, the users should be able to meet each other. The indicator may be a light, a vibrator, a speaker or any other mechanism which can inform the user that a match has been detected. If the identification code is not on the listing of matched identification codes, the PDD does not actuate the match indicator.

In an embodiment, the PDD does a secondary check to determine if there is a match. If the PDD receives an identification code which is not on the listing of matched identification codes, it can request profile information. The transmission of additional information and a back up match analysis is performed to avoid match errors. For example, a PDD may not recognize the identification code of a new user as a match because the listing of matched identification codes was downloaded before the second user's identification code was assigned. To avoid this type of match error, the PDDs may transmit and receive profile information and determine if there is a match even if the identification code is not on the listing of matched identification codes. Match errors may further be avoided by having the matched PDD verify the match before actuating the match indicators. By actuating the match indicator based upon the identification code as well as a verification of profile information rather than identification codes alone, match errors are reduced.

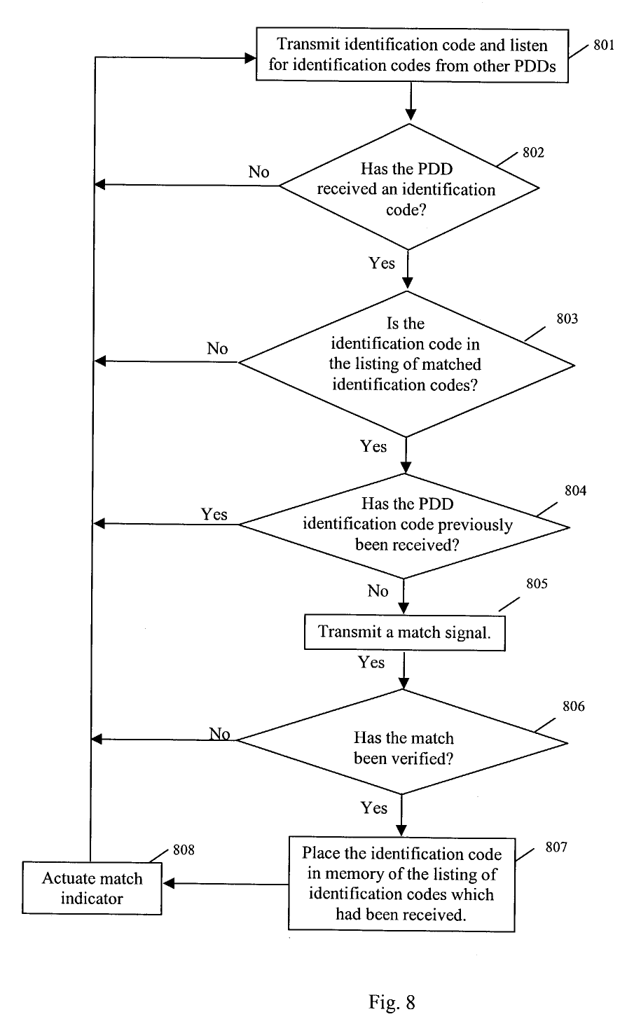

The detection of matched PDDs in a peer to peer mode, is described with reference to the flow chart illustrated in FIG. 8. The PPD transmits its identification code and then listens for identification codes from other PDD 801. The PDD then determines if any identification codes have been received 802. The PDD must within the transmission range of another device in order to receive the identification code. If the PDD does not receive any identification codes, it returns to the transmit and listen step 801. If the PDD receives an identification code it then determines if the identification code is on the listing of matched identification codes 803. If the identification code is not on the listing of matched identification codes the PDD goes back to the transmit and listen step 801. If the identification code is on the listing of matched identification codes, the PDD determines if the identification code was previously received 804.

The PDD may determine if the identification code has been previously received by comparing the identification code to the received identification codes which have been stored in memory. If the identification code is in the received identification code memory, the PDD returns to the transmit and listen step 801. If identification code is not in the received identification code memory, the PDD may transmit a match signal to the matched PDD to verify that there is a match 805. The PDD then determines if the match is verified 806. The match verification is based upon a returned verification signal from the matched PDD. If the match is verified the PDD places the identification code in the received identification code memory 807 and the match indicators of the PDDs are actuated 808. The PDD then returns to the transmit and listen step 801 and the identification code matching process is repeated.

The match indicator may have several operating conditions: off, actuated and standby. Normally the match indicator is in the standby mode waiting for the PDD to be matched with another PDD. The match indicator is actuated when the PDD finds a matched PDD. Upon determining who the matched PDD is, the user can turn the match indicator off allowing the matched users to talk without interruption. Even though the match indicator can be deactivated, the PDD may still acquire additional matched identification code information from other PDDs. Alternatively, while the match indicator is deactivated, the PDD may obtain an update the listing of matched identification codes from the host computer or PDD user database or perform other computational functions. The user is not notified of the detected match while the match indicator is deactivated, however the acquired information can still be obtained by the user at a later time. The user can access these identification codes through the visual display, when the match indicator is turned back on or when the PDD communications are uploaded to the PC. When the user would like to resume meeting matched PDDs, the match indicator can be manually switched to the standby mode. The identification codes of all matched users may be placed in the received identification code memory to prevent rematching or for access by the PDD user at later time.

In an embodiment, the PDDs communicate in a manner that insures that if a match is detected, the match indicators will be actuated simultaneously. During the transmitting step, a first PDD transmits a first identification code. A second PDD receives the first identification code and determines that there is a match because the first identification code is on the listing of matched identification codes. The second PDD transmits a second identification code followed by the first identification code indicating that there may be a match. The first PDD receives the first and second identification codes and tries to verify that the second identification codes is on its downloaded listing of matched identification codes. If the first PDD confirms the match a signal indicating a match is transmitted. Both PDDs actuate their match indicators to inform the users of the match.

During the above described match detection process, if the second identification code is not on the first PDD's listing of matched identification codes, the first PDD transmits a signal indicating that the identification code is not on the listing of matched identification codes. The second PDD responds by transmitting the profile information of the second user. The first user receives the profile information and performs a match analysis. If the second user's profile is a match, the first PDD transmits a signal verifying that the first and second PDDs are matched. Both the first and second PDDs may then actuate their match indicators to inform the users of the match. Various other methods may be used to insure that all matches are properly detected and that the match indicators are actuated simultaneously.

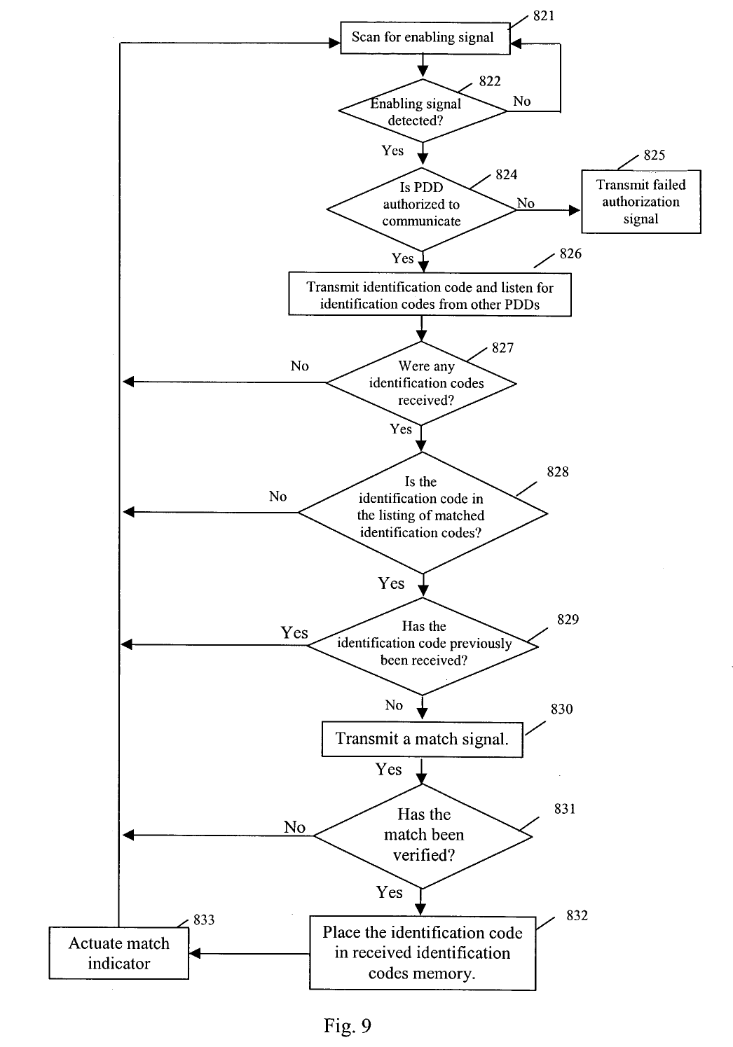

FIG. 9 is a flowchart which describes the operation of the PDD in an embodiment where the PDD has downloaded a listing of matched identification codes and an enabling signal is required for the PDD to transmit or receive information. The match indicator is set to standby and the PDD scans for the enabling signal 821. The enabling signal is transmitted by an area host computer and may target a specific PDD or all PDDs in the transmission range. If the enabling signal is received the PDD determines if it is authorized to communicate 824. The authorization step may include transmitting an identification code to the area computer which determines if the PDD is authorized and transmits an authorization signal to the PDD. In an embodiment, the enabling and authorization steps may be combined so the area computer enables and authorizes communications in the same step. A PDD may fail to be authorized for various reasons including a failure to pay service billings and abuse of the system rules. If the PDD is not authorized, an authorization failure signal is transmitted to the PDD and an indication of authorization failure may be displayed by the PDD 825.

If the PDD is authorized, the PDD transmits the identification code and listens for identification codes from other PDDs 826 in the manner similar to that described with reference to FIG. 8. The PDD determines if an identification code has been received 827. If an identification code is received, the PDD determines if the identification code is on the listing of matched identification codes 828. If identification code is on the list of matched identification codes, the PDD determines if the identification code has been previously received 829. If the PDD has not previously received, the PDD transmits a match signal 830. The PDD then waits for a verification signal 831. If a verification signal is received, the identification code is placed in the received identification code memory 832 and the match indicator is actuated 833. The PDD may then returns to the scan for an enabling signal step 821.

Because the host computer acts as a conduit for much of the communications in the area, the host computer may also analyze the personal information of the PDD users in the monitored area. For example, the computer may be able to monitor specific demographics of the patrons. By compiling the demographic information, customer profiles can be generated for venues including: age range, gender, and interests. The analysis of the information can also be used to determine the effectiveness of the system by determining the total number of users in an area and the number of resulting matches. The computer analysis may be useful as a marketing tool to monitor business clientele and improve the knowledge of the target market. The information can also be made available over the internet allowing PDD users access to club's statistical information.

As discussed, advertisements may be received and displayed or communicated to the user by the PDD. In an embodiment, advertisers can analyze the general information of the PDD users and selectively direct their advertisements at the target PDD user demographic group. For example, a calcium supplement company may only wish to target women over the age of 35. Similarly, an energy drink manufacturer may only wish to advertise to individuals between the ages of 18-35.

FIGS. 8 and 9 illustrate exemplary PDD operating modes. Various changes can be made to the operating processes without exceeding the scope of the invention. In particular, the order of the processing steps can be rearranged or varied and produce the same matching process outcome. Although the use of PDDs in various dating applications has been described, the PDDs can also be used for various other applications. For example, a PDD can be configured to detect the presence of a specific individual by detecting a specific identification code. The PDD is set by the user to only actuate the match indicator when a specific identification code is detected. This type of capability may be useful when it is necessary or desirable to meet a specific person(s) in a crowded space or on a blind date. This embodiment may also be used by visually or hearing impaired individuals to discretely detect the presence of friends or others PDD users having a similar physical characteristics.

In another embodiments, the inventive PDD device can also be used in commercial applications. The inventive system can assist a PDD user in wirelessly obtaining information from a network of wireless transceiver devices. In this embodiment, the user configures the PDD to transmit a query signal indicative of the information that is of interest. The network of wireless transceivers responds to the query signal by providing the requested information. In a commercial embodiment, the user may input search data related to a consumer item. For example, the user may be interested in buying a toaster which is has a chrome finish, able to toast four slices of bread, priced between $15 to $50. In this embodiment, the PDD transmits the toaster information as search data to a computer having a compatible transceiver associated with one or more stores. The computer compares the search data to an inventory database to determine if there are any toasters that match the user's requirements. If a matching toaster is in the inventory database, the computer transmits information about the toaster to the PDD. The PDD receives the toaster information, activates the match indicator and displays the toaster information and photograph of the toaster on the PDD's visual display. The user can review the toaster information and make an informed decision about whether to look at the product first hand. The user can reset the PDD to investigate other appliance stores.

The PDD may also be used to obtain directional information in a large mall for a PDD user who is interested in toasters. In this embodiment, the user may configure the PDD device to obtain directions to stores which carry toasters. In general, most malls have only a few entrances. A PDD transceiver may be positioned at each entrance. When the user passes through the entrance, the PDD transceiver detects the “toaster” inquiry from the user's PDD and searches on a database for stores that carry toasters and the directions to each store. The store names, directions to the stores and location of the item within the stores may be transmitted to the user's PDD. The user can read the store names and select the desired directions from the PDD's visual display. The store directions to the PDD can be detailed or partial depending upon the arrangement of PDD transceivers in the mall.

If the directions are partial, the user follows the initial directions and as the user travels through the mall, the PDD continues to transmit the “toaster” inquiry. When the user travels past a PDD transceiver the “toaster” inquiry is received and revised directions from the new location are transmitted to the PDD. When the user enters the target store, a store PDD transceiver receives the “toaster” inquiry and transmits the exact location of the toasters within the store to the PDD.

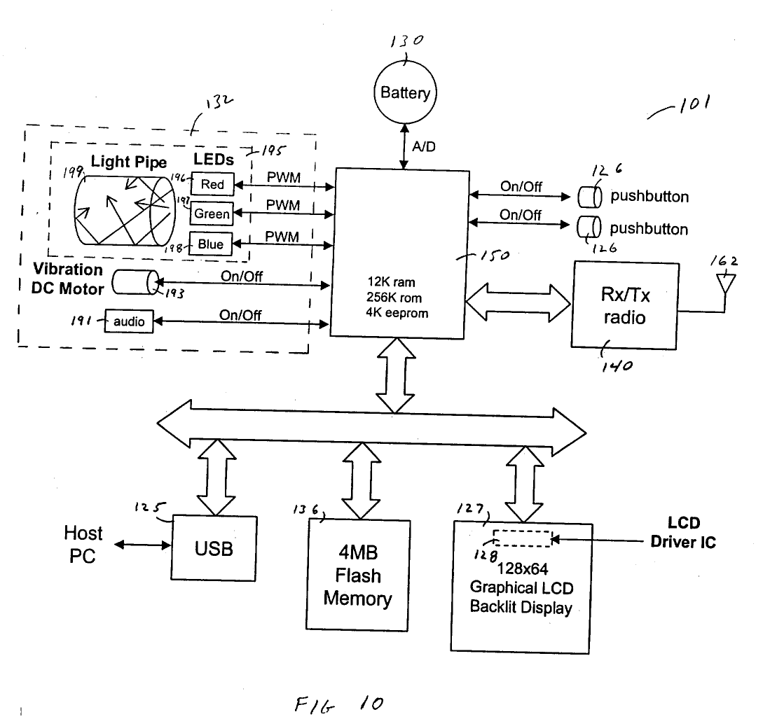

The PDD units utilize the same basic components for all described modes of operation and applications. An exemplary block diagram of the PDD components is illustrated in FIG. 10. The PDD may include: a micro-controller 150, a match indicator 132, flash memory 136, an input/output port 125, user input buttons 126, an graphical display 127, an RF chip 140 and an antenna 162. The micro-controller (MCU) 150 has a central processing unit (CPU), ROM memory and RAM memory. The operating system program, may be stored in the memory of the micro-controller 150. The identification code and the listing of matched user identification codes may be stored on the flash memory 136. The micro-controller 150 may be connected to an I/O port 125, a user graphical display unit 127, an RF unit 140 and a match indicator unit 132. The I/O port 125 is used to communicate and exchange information with the computer. The I/O port 125 is used to connect the PDD 101 to the PDD user database through a personal computer having an internet connection. Typically, the I/O port 125 utilizes a wired connection to a personal computer which is described in reference to FIG. 6. Alternatively, the PDD 101 may utilize wireless communications to access the PDD user database.

The flash memory 136 may be build into the PDD 101 or be a commercially available removable component. Removable flash memory devices 136 include: memory stick, compact flash, smart media, and secure digital device. In an embodiment, the listing of matched user identification numbers can be transferred between the PDD and the personal computer through the removable flash memory 136 alone without the need to connect the PDD 101 directly to the personal computer. Alternatively, data can be transferred to the flash memory through the USB connection 125 to the personal computer.

The user control pushbuttons 126 allow the user to manually control the operation of the PDD 101. The user control pushbuttons 126 can include: an on/off button and match indicator control buttons. The on/off button turns the PDD 101 on or off upon the command of the user. The match indicator control buttons control the operation of the match indicator 132. A button can change the output mode between light, visual display, vibration and audio alarm. A switch can also change the match indicator mode between: standby and off.

The match indicator unit 132 can include various indicator mechanisms including: a vibrator 193, light 195, speaker 191 or any other device which may notify the user of a match. The vibrator 193 may be a motor connected to an off axis weight. When the vibrator is actuated the motor rotates the weight causing the PDD 101 to vibrate. The light may comprise a light pipe 199 which receives the light emitted by a red LED 196, a green LED 197 and a blue LED 198 at one end and emits a single color light at the opposite end. The color emitted by the light pipe 199 can be changed almost infinitely by adjusting the outputs of the LEDs 196, 197, 198. In an embodiment, when a match is detected, the match indicators of the PDDs display the same color. By comparing the colors, the users can easily determine who they are matched with. The specific color output can be communicated to the PDDs during the match verification communications.

The PDD 101 may also include a visual display unit 127 which can be a light emitting diode (LED), a liquid crystal display (LCD) or any other type of small alphanumeric display which can display text information from the PDD, the server, a matched PDD or an area computer. The text message may display text information for the identification codes or diagnostic information for PDD operations. The visual display 127 may also be able to display pictures. In an embodiment, a digital picture may be part of the identification code. When the PDD 101 is matched, the picture of the matched user is displayed on the visual display 127. The picture assists the PDD user in identifying the matched PDD user.

The MCU that performs various PDD functions such as scanning for identification and enabling signals, transmitting identification codes, communicating with a host computer, comparing personal information to search data and actuating the match indicator when a match is detected. The MCU performs these tasks using application programs stored in the ROM. These application programs are loaded into the RAM from the ROM. The ROM may also store algorithms which convert the analog signals to digital signals, perform error checking and correction as well as remove noise from the analog signals. These algorithms are loaded into RAM when needed for analog signal processing. When improvements to the algorithms or application program are made, the software updates can be loaded into the PDD by reflashing the ROM. The reflashing allows the PDD 101 to keep up to date with the latest software improvements and RF communications protocols.

Although the memory of the PDD is preferably large enough to store all the program algorithms and many identification codes, there may be a situation where the memory is full and some identification codes must be removed from the received identification code memory. In an embodiment, a “FIFO” (First In First Out) system may be used in which the first identification codes stored in memory are the first to be removed. Various methods may be used to prevent rematching with an identification code which has been removed from the received identification code memory. The identification codes in the received identification code memory may be transmitted and stored on the PDD user database or the user” personal computer. When the PDD downloads an updated listing of matching identification codes, the PDD may user database may automatically remove the identification codes which were in the PDD's received identification code memory from the listing of matched identification codes. Alternatively, the PDD user's personal computer may be used to remove all identification codes which were in the PDD's received identification code memory from the listing of matched identification codes.

As discussed, when the personal information of the users matches the search data, the match indicators of the PDDs are actuated. The PDD match indicators can have several modes of operation which may be controlled by the user. These modes of operation may include: ghost, blink, vibrate, random and cloak. Each mode has distinct characteristics which may be selected depending upon how the user would like to use the PDD. When the PDD is matched in ghost mode, the contact information is wirelessly exchanged, but the indicator is not actuated to immediately inform the user of a match.

When the PDD is matched in the blink mode, contact information is wirelessly exchanged, a vibrator may be actuated and a light on the matched PDD is illuminated. The illuminated light can be seen by the user of the PDD as well as the matched PDD user. The lights of the matched PDDs may be coordinated so that they blink at the same frequency or are the same color so that the matched PDDs can more easily locate each other.

When the PDD is matched in vibrate mode, contact information is wirelessly exchanged and a mechanical vibrator in the PDD runs. The vibration notifies the wearer that a match has been detected but people around the user will not know that the user's PDD indicator has been actuated. In an embodiment, the light or vibration indicators are only actuated when they are within a predetermined proximity of the matched PDD and are deactivated when the distance between the matched PDDs exceeds the predetermined distance. If the matched PDD come within the predetermined distance, the match indicators are reactivated. The intermittent actuation of the match indicator is terminated when the PDD is reset or the match indicator is turned off.

When matched in random mode, the search data is of the PDD is removed and the PDD is matched when any other PDDs in the transmission radius which are also in random mode is detected. The indicators of the random mode PDDs are actuated when a random match is detected. The contact information may or not be exchanged.

When matched in the cloak mode, the user's PDD can detect matched PDDs that are not in cloak mode but the other PDDs cannot detect the user. The user can receive contact information from the matched PDD which is not in cloak mode, but the other PDD does not receive the contact information of the cloaked PDD. Similarly, the indicator on the cloaked user's PDD may actuate to inform the user of a match, but the other matched PDD's indicator is not actuated. Table 2 provides a chart of the possible PDD responses to being matched.

TABLE 2

| | Cloak | Ghost | Vibrate | Blink | Random |
|---|---|---|---|---|---|
| Contact Information | Yes | Yes | Yes | Yes | No |
| Received From | | | | | |
| PDD's Not In Cloak | | | | | |
| Mode | | | | | |
| Contact Information | No | Yes | Yes | Yes | No |
| Transmitted | | | | | |
| Match Indicator | Optional | No | Vibration | Light & | Yes |
| | | | | Vibration | |

Some match indicator operating modes are incompatible with other modes. For example, two PDDs in cloaked mode without the light or vibration enabled may be matched but there may be no resulting interaction because contact information is not transmitted and the indicators have been disabled.

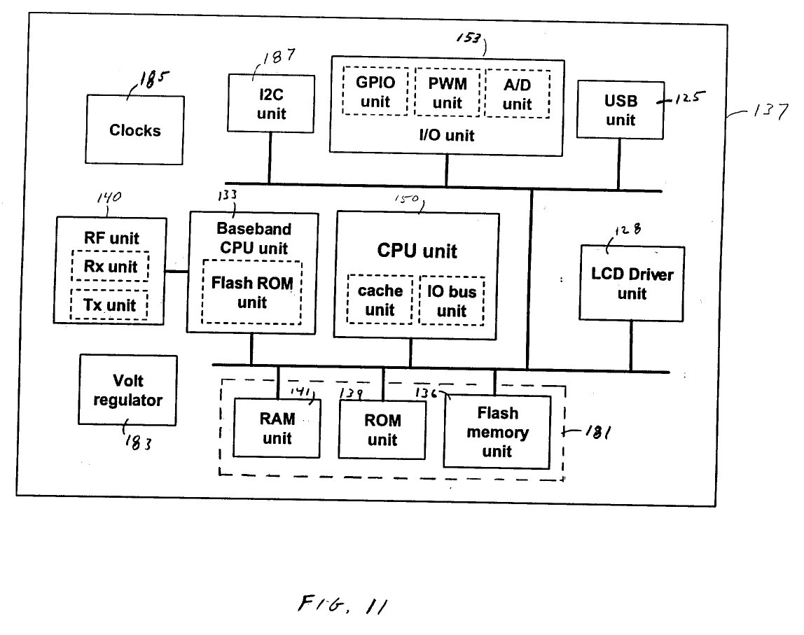

FIG. 11 is a more detailed block diagram of an application specific integrated circuit (ASIC) embodiment of the PDD. In this embodiment, the Rx/Tx Radio unit 140, the baseband CPU 133, CPU 150, RF unit 140, clocks 185, “12C unit” 187, input/output interfaces 153, USB 125, LCD driver 128, memory components 181 (RAM unit 141, ROM unit 139, flash memory unit 136) and voltage regulator 183 are built into a single application specific integrated circuit (ASIC) 137. By integrating the core PDD components into a single ASIC, the PDD can be integrated into other existing consumer electronic devices such as PDAs, cell phones, pagers and MP3 players. Because the ASIC and RF transceiver require very little space, the PDD can be installed within the housing of existing consumer electronic devices.

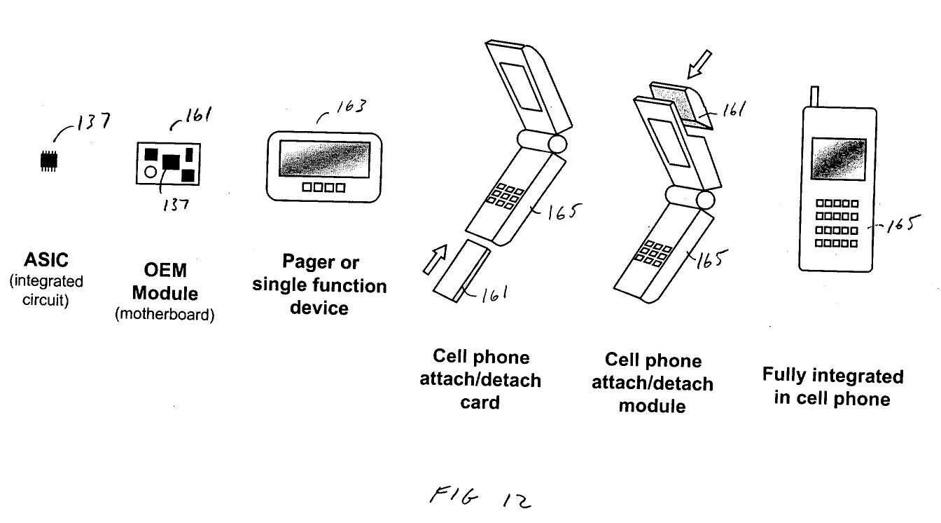

FIG. 12 illustrates some particularly suitable consumer electronic devices have visual displays, lights, speakers and input controls. The PDD device may be integrated into the consumer electronic devices through an ASIC chip 137 or as a plug in module 161 which may also include the ASIC chip 137. The ASIC 137 may be integrated into a pager device 163 or a cell phone 165. Alternatively, the plug in module 161 may be inserted into an expansion slot of the cell phone 165 attached as an add on device.

Communications between the inventive PDDs is over short range RF signals. If there are a large number PDDs in an area, the RF communications may be problematic because of RF interference. In some situations, communications signals may be transmitted over the same communications channel. When two signals use the same channel, interference or a “collision” occurs and RF signals may not be received by the intended receivers. Various systems may be applied to prevent interference and collisions.

CSMA/CD (Carrier Sense Multiple Access/Collision Detection) is a type of contention protocol that may be used by PDDs to detect collisions and respond after the collision is detected. The CSMA/CD provides a set of rules for determining how to respond when two devices attempt to use a data channel simultaneously. After detecting a collision, a device waits a random delay time and then attempts to re-transmit the message. The probability of each device waiting the same period of time is unlikely. If the PDDs detect a collision again, they wait a longer period of time before re-transmitting the message. This delay after collision is known as “exponential back off.”

A method for reducing the interference of transmitted signals is to distribute the transmitted signals over the range of frequencies based upon the PDD use. In the previously described dating applications, different frequencies may be used for different match interests. A first frequency or frequency range may be used by men seeking women, a second frequency may be used by women seeking men, a third frequency may be used by men seeking men and a fourth frequency may be used by women seeking women. By designating the frequencies as described, the transmitter and receiver frequencies can be configured to the user's needs. By spreading the PDD communications over a range of frequencies, more PDD users can communicate without interference.

Collisions on a single radio frequency may also be avoided by utilizing a spread spectrum algorithm which are known methods of preventing communication interruptions due to collisions. Spread spectrum technology which allows multiple devices to communicate simultaneously using a range of frequencies. Spread spectrum use fast codes that run many times the information bandwidth or data rate to avoid jamming and eavesdropping of signals transmitted between PDDs. The spread spectrum scheme is accomplished by spreading the transmitted signals over a range of frequencies, such as 902 MHz to 928 MHZ and at 2.4 GHz to 2.484 GHz. Signals transmitted at these frequencies do not require an FCC license. The two primary types of spread spectrum are frequency hopping and direct sequence.

The frequency hopping spread spectrum technique broadcasts communications signals over a random series of radio frequencies. A receiver, hopping between frequencies in synchronization with the transmitter, receives the message. The message can only be fully received if the sequence of transmission frequencies is known. The intended PDD receiver knows the transmitter's hopping sequence and is the only receiver can successfully receive all of the data.

Another spread spectrum communication scheme is called “direct sequence” or pseudonoise. The direct sequence method is one that most wireless spread- spectrum LANs use. The direct sequence transmitters spread their transmissions by adding redundant data bits called “chips” to them. Direct sequence spread spectrum adds at least ten chips to each data bit. Like a frequency hopping receiver, a direct sequence receiver must know a transmitter's spreading code to decipher data. This spreading code allows multiple direct sequence transmitters to operate in the same area without interference. Once the receiver has all of the data signals, it uses a correlator to remove the chips and collapse the signal to its original length.

There are several distinctions between frequency hopping and direct sequence spread spectrum communications. Frequency hopping currently use less power than direct sequence, but direct sequence has a faster data transmission rate of about 8 Mbps whereas frequency hopping transmissions have a practical limit of 2 Mbps. Because PDDs are intended to be small and inexpensive portable devices, a the frequency hopping spread spectrum may be preferable.

In the foregoing, a wireless communications system has been described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

1. A wireless communications system comprising:
(a) a server computer having a user database which stores listings of matched identification codes for a plurality of portable digital device users; and
(b) a first portable digital device having:
a first memory for storing a first identification code and a first listing of matched identification codes for a first portable digital device user;
a first microprocessor;
a first radio frequency transceiver; and
a first match indicator; and
(c) a network providing a communications link between the server computer and the first portable digital device for downloading the first listing of matched identification codes from the user data base to the first memory of the first portable digital device.

2. The wireless communications system of claim 1 further comprising:
a computer which is in communication with the first portable digital device and has access to the server computer through the connection for downloading the first listing of matched user identification codes from the user database to the first portable digital device.

3. The wireless communications system of claim 1 wherein the first match indicator is actuated when the first portable digital device receives a second identification code and the second identification code is on the first listing of matched identification codes.

4. The wireless communications system of claim 1 further comprising:
a second portable digital device having:
a second memory for storing a second identification code and a second listing of matched identification codes;
a second radio frequency transceiver; and
a second match indicator,
wherein the first match indicator is actuated when the first portable digital device receives a second identification code from the second portable digital device and the second identification code is on the first listing of matched identification codes.

5. The wireless communications system of claim 4, wherein the second match indicator is actuated when the second portable digital device receives the first identification code from the first portable digital device and the first identification code is on the second listing of matched identification codes.

6. The wireless communications system of claim 1 further comprising:
a second portable digital device having:
a second memory for storing a second identification code, a second listing of matched identification codes and a second listing of previously received identification codes;
a second radio frequency transceiver; and
a second match indicator,
wherein the second match indicator is actuated when the second portable digital device receives the first identification code from the first portable digital device, the first identification code is on the second listing of matched identification codes and the first identification code is not on the first listing of previously received identification codes.

7. The wireless communications system of claim 1 wherein the first portable digital device further comprises a visual display for displaying a digital photograph.

8. The wireless communications system of claim 7 wherein an advertisement display is stored in the first memory and the first portable digital device further comprises a visual display which periodically or continuously displays the advertisement display.

9. The wireless communications system of claim 1 wherein the first memory, the first microprocessor and the first radio frequency transceiver are fabricated on a single application specific integrated circuit.

10. The wireless communications system of claim 1 wherein the first portable digital device is integrated into a cell phone.

11. A wireless communications system comprising:
(a) a first portable digital device having:
a first memory for storing a first identification code and a first listing of matched identification codes for a first portable digital device user;
a first microprocessor;
a first radio frequency transceiver; and
a first match indicator; and
(b) a second portable digital device having:
a second memory for storing a second identification code and a second listing of matched identification codes for a second portable digital device user;
a second microprocessor;
a second radio frequency transceiver; and
a second match indicator.

12. The wireless communications system of claim 11 further comprising:
a first computer which has access to the server computer through the connection for downloading the first listing of matched user identification codes from the user database to the first portable digital device; and
a second computer which has access to the server computer through the connection for downloading the second listing of matched user identification codes from the user database to the second portable digital device.

13. The wireless communications system of claim 11 wherein the first portable digital device transmits a match signal when the first portable digital device receives the second identification code and the second identification code is on the first listing of matched identification codes.

14. The wireless communications system of claim 11 wherein the second portable digital device actuates the second match indicator and transmits a verification signal when the second portable digital device receives the match signal and the first identification code is on the second listing of matched identification codes.

15. The wireless communications system of claim 11 wherein the first portable digital device actuates the first match indicator when the first portable digital device receives the verification signal from the second portable digital device.

16. The wireless communications system of claim 11 wherein the second portable digital device actuates the second match indicator when the second portable digital device receives the match signal and the first identification code is on the second listing of matched identification codes.

17. The wireless communications system of claim 11 wherein the first portable digital device transmits a match signal when the first portable digital device receives the second identification code, the second identification code is on the first listing of matched identification codes and a photo of the second portable digital device user is approved by the first portable digital device user.

18. The wireless communications system of claim 13 wherein the second portable digital device actuates the second match indicator and transmits a verification signal when the second portable digital device receives the match signal, the first identification code is on the second listing of matched identification codes and a photo of the first portable digital device user is approved by the second portable digital device user.

19. The wireless communications system of claim 111 wherein an advertisement display is stored in the first memory and the first portable digital device further comprises a visual display which periodically or continuously displays the advertisement display.

20. The wireless communications system of claim 11 wherein the first memory, the first microprocessor and the first radio frequency transceiver are fabricated on a single application specific integrated circuit.

21. The wireless communications system of claim 11 wherein the first portable digital device the second portable digital device are both integrated into cell phones.

22. A wireless communications method comprising the steps:
providing a first portable digital device having a first memory, a first microprocessor, a first transceiver, a first identification code and a first match indicator;
producing a first listing of matched identification codes for a first user;
storing the first listing of matched identification codes in the memory of the first portable digital device;
providing a second portable digital device having a second memory, a second microprocessor, a second transceiver, a second identification code and a second match indicator;
producing a second listing of matched identification codes for a first user;
storing the second listing of matched identification codes in the second memory of the second portable digital device; and
transmitting the first identification code to the second portable digital device.

23. The wireless communications method of claim 22 further comprising the steps:
actuating the second match indicator if the second identification code is on the first listing of matched identification codes.

24. The wireless communications method of claim 22 further comprising the steps:
transmitting a match code to the first portable digital device if the second identification code is on the first listing of matched identification codes.

25. The wireless communications method of claim 24 further comprising the steps:
actuating the first match indicator if the second identification code is on the first listing of matched identification codes.

26. The wireless communications method of claim 22 further comprising the steps:
transmitting a verification code to the second portable digital device if the second identification code is on the first listing of matched identification codes; and
actuating the second match indicator.

27. The wireless communications method of claim 22 further comprising the steps:
storing a first listing of previously received identification codes in the first memory;
actuating the second match indicator if the second identification code is on the first listing of matched identification codes and the second identification code is not on the first listing of previously received identification codes.

28. The wireless communications method of claim 22 further comprising the steps:
storing a second listing of previously received identification codes in the second memory;
transmitting a match code to the first portable digital device if the first identification code is in the second listing of matched identification codes and the first identification code is not on the second listing of previously received identification codes.

29. The wireless communications method of claim 28 further comprising the steps:
storing a first listing of previously received identification codes in the first memory;
transmitting a verification signal to the second portable digital device if the first identification code is in the first listing of matched identification codes and the second identification code is not on the first listing of previously received identification codes.

30. The wireless communications method of claim 22 wherein the second portable digital device further comprises a visual display for displaying a digital photograph further comprising the steps:
transmitting an electronic photo of a first user to the second portable digital device; and
displaying the electronic photo of a first user to the second portable digital device.

31. The wireless communications method of claim 22 wherein the second portable digital device further comprises a visual display for displaying an advertisement further comprising the steps:
transmitting an advertisement to the second portable digital device; and
displaying the advertisement on the visual display of the second portable digital device.

32. The wireless communications system of claim 22 wherein an advertisement display is stored in the first memory and the first portable digital device further comprises a visual display which periodically or continuously displays the advertisement display.

33. The wireless communications system of claim 22 wherein the first portable digital device the second portable digital device are both integrated into cell phones.
